(19) United States
(12) Patent Application Publication
(10) Pub. No.: US 2024/0169311 A1
(43) Pub. Date: May 23, 2024

(54) Method For High-Frequency Warehouse Shelf Inventory Snapshot

(71) Applicant: Vimaan Robotics, Inc., Santa Clara, CA (US)

(72) Inventors: Chahal Neema, Santa Clara, CA (US); Deepak Pingalay, Santa Clara, CA (US); Dheepak Khatri, Milpitas, CA (US); Srinivasan K. Ganapathi, Palo Alto, CA (US); Oscar Hernandez, Santa Clara, CA (US); Prateek Jaya Prakash, Santa Clara, CA (US); Sudhir Singh, Santa Clara, CA (US); Sumil Majithia, Cupertino, CA (US)

(21) Appl. No.: 18/514,002

(22) Filed: Nov. 20, 2023

Related U.S. Application Data
(60) Provisional application No. 63/426,762, filed on Nov. 20, 2022.

(51) Int. Cl. G06Q 10/087; B66F 9/075

(52) U.S. Cl. CPC G06Q 10/087; B66F 9/0755

(57) ABSTRACT

A mobile sensor frame (aka StorTRACK) for warehouse inventory management is provided. The mobile sensor frame has forklift sleeves to allow handling by a forklift truck. A vertically oriented frame is mounted and has multiple cameras distributed thereon. A motor-controlled translation system is onboard for moving the vertically oriented frame in vertical direction along with the platform. An on-board computer is used for controlling operational control of the mobile sensor frame by monitoring the direction of motion of the mobile sensor frame relative to a ground surface, and performing data acquisition of the multiple cameras. The mobile sensor frame allows for faster cycle counting at a larger footprint than e.g. a drone system.

### CROSS-REFERENCE TO RELATED APPLICATIONS

This application claims priority from U.S. Provisional Patent Application 63/426,762 filed Nov. 20, 2022, which is incorporated herein by reference.

### FIELD OF THE INVENTION

This invention relates to methods and system of warehouse shelf inventory management.

### BACKGROUND OF THE INVENTION

Tracking inventory in shelves is critical for improving operational efficiency inside a warehouse. Most warehouses have discrepancies between what the warehouse management system (WMS) says and what the actual inventory on the floor is. The accuracy of the WMS depends on many factors like the velocity of inventory movement, processes, level of technology used, type of inventory, frequency of cycle counting-validation, search etc. In a dynamic warehouse with low process compliance or sometimes, even absence of good standard practices, the inventory accuracy in WMS can be as low as 50%. Warehouses typically employ different ways to cycle count their inventory.

Most common way is using a hand-scan gun. Warehouse personnel reaches the bin in a cherry picker and scans each item and associates it to a bin location. In most cases this method utilizes the same infrastructure as already available in the warehouse. It is also intuitive for operators because they get visual/audio feedback from the scan gun every time a scan happens. However, the process is slow and labor intensive as the scan happens one item at a time. It also allows for opportunities for mis-scans. Operators leaning into the bins to scan items at higher elevation can also be unsafe.

There have been considerations to utilize alternate methods to cycle count using more technology. Two suggested methods are adding scanners to autonomous vehicles (e.g. aerial and ground), and attaching scanners to the forklift/order pickers that can be driven by a forklift operator to desired location for scanning. In case of autonomous scanning—either aerial or ground based—there is very little human involvement, which makes the process safer and significantly reduces labor. However, critics argue that perceived safety risks regarding autonomous drones or tall telescopic masts mounted on mobile robots moving near humans and vehicles remain high.

Attachment sensors to the forklifts and cherry pickers to scan items in a semi-autonomous manner have also been explored. For example, two main methods that have been explored include: modifying the Material Handling Equipment (MHE) by permanently attaching barcode scanners, and the other approach is to attach a payload to the forks by presenting it to the forks and clamping it down. The former approach requires an expensive purpose built retrofit to one dedicated MHE in the warehouse. The latter needs an operator to attach and detach a heavy sensor suite by lifting and bringing to the forklift. This can be unsafe and prone to injury.

### SUMMARY OF THE INVENTION

In one embodiment, the present invention is a mobile sensor frame (also referred to as StorTRACK) for warehouse inventory management. The mobile sensor frame has a platform with a bottom surface and a top surface. In one example, wheels are distributed at the bottom surface of the platform. Fork-lift sleeves distributed at the bottom surface or the top surface of the platform to allow a forklift truck to insert the forks into two of the fork-lift sleeves. A vertically oriented frame is mounted at the top surface of the platform. A motor-controlled translation system is onboard for moving the vertically oriented frame in vertical direction along with the platform. Multiple cameras are distributed on the vertically oriented frame. In one embodiment, laser pointers are mounted for assisting in location control. In one embodiment, an on-board computer is used for controlling operational control of the mobile sensor frame by controlling the wheels and therewith the direction of motion of the mobile sensor frame relative to a ground surface, controlling the motor-controlled translation system for moving the vertically oriented frame in vertical direction relative to the platform, performing data acquisition of the multiple cameras, and performing data acquisition of the laser pointers. In another embodiment, an on-board computer is used for controlling operational control of the mobile sensor frame by monitoring the direction of motion of the mobile sensor frame relative to a ground surface, and performing data acquisition of the multiple cameras.

In another embodiment, the present invention is a warehouse inventory acquisition management method. The method relies on having and operating the mobile sensor frame as defined in the above embodiment. The method further includes the mobile sensor frame (self)-controlling (or being remotely controlled for) movement and positioning through aisles in a warehouse, where the warehouse comprises racks with inventory. The method further includes acquiring inventory information of the inventory using the multiple cameras while the vertically oriented frame is translated in the vertical direction relative to the platform.

Embodiments of the invention have the following advantages:
Faster way of cycle counting, along with evidence and images;
Works with existing warehouse equipment like forklift and order-pickers;
As a large footprint is available as compared to a drone, large battery, more compute and more sensors are available on-onboard. This allows more information to be extracted like depth, smaller fonts on the labels with 8 hours of operations. As the image processing can happen onboard, it improves the data reporting turn-around time.
High density racking with multiple boxes in one bin location benefit more from this technology because StorTRACK can scan multiple boxes together thus making it much faster than a human who scans one box at a time with a scan gun.

### BRIEF DESCRIPTION OF THE DRAWINGS

FIG. 1 shows according to an exemplary embodiment of the invention the mobile sensor frame 100 (aka as scanning frame or sensor cart on a Material Handling Equipment (MHE).

FIG. 2 shows according to an exemplary embodiment of the invention details of the mobile sensor frame 100.

FIG. 3 shows according to an exemplary embodiment of the invention a scanning method with repeated vertical motions after moving certain distance forward.

FIG. 4 shows according to an exemplary embodiment of the invention the pallet-like design features enabling the lifting by a forklift.

FIG. 5 shows according to an exemplary embodiment of the invention the mobile sensor frame getting attached to the forklift without driver getting down.

FIG. 6 shows according to an exemplary embodiment of the invention two camera arrays allowing the capture from floor to ceiling without roof collisions.

FIG. 7 shows according to an exemplary embodiment of the invention laser pointers assisting alignment of cameras along the aisle.

FIG. 8 shows according to an exemplary embodiment of the invention laser pointer shining on the ground to assist maintaining distance from the rack.

FIG. 9 shows according to an exemplary embodiment of the invention UI screen in operator cabin with display 910.

FIG. 10 shows according to an exemplary embodiment of the invention control operations.

### DETAILED DESCRIPTION

This invention provides a device and method of improving shelving inventory accuracy in a warehouse by making it faster and safer. It addresses the drawbacks of current methods described supra. Warehouse refers to a building that stores items in shelves, and it includes retail stores, fulfilment centers and distribution centers.

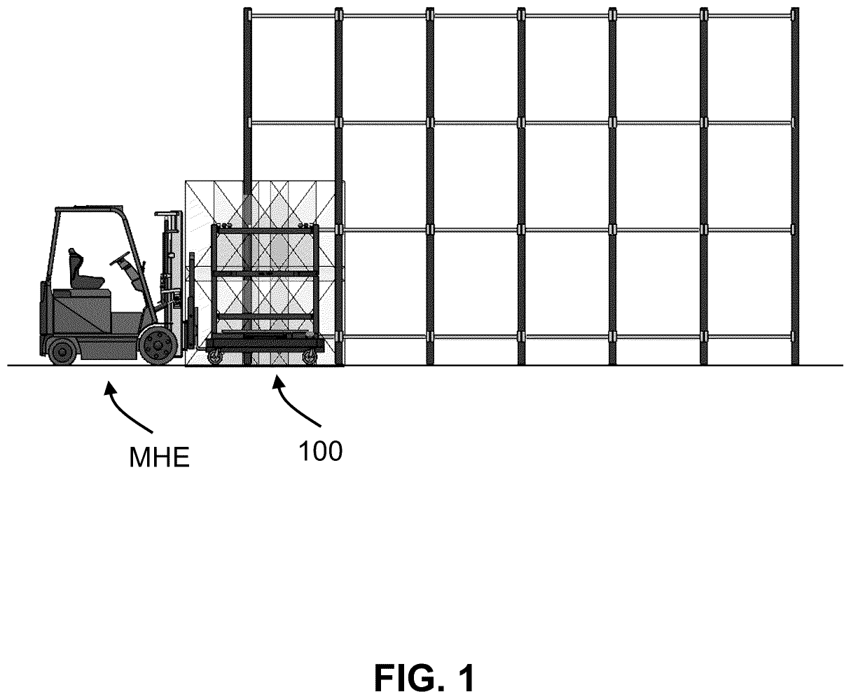

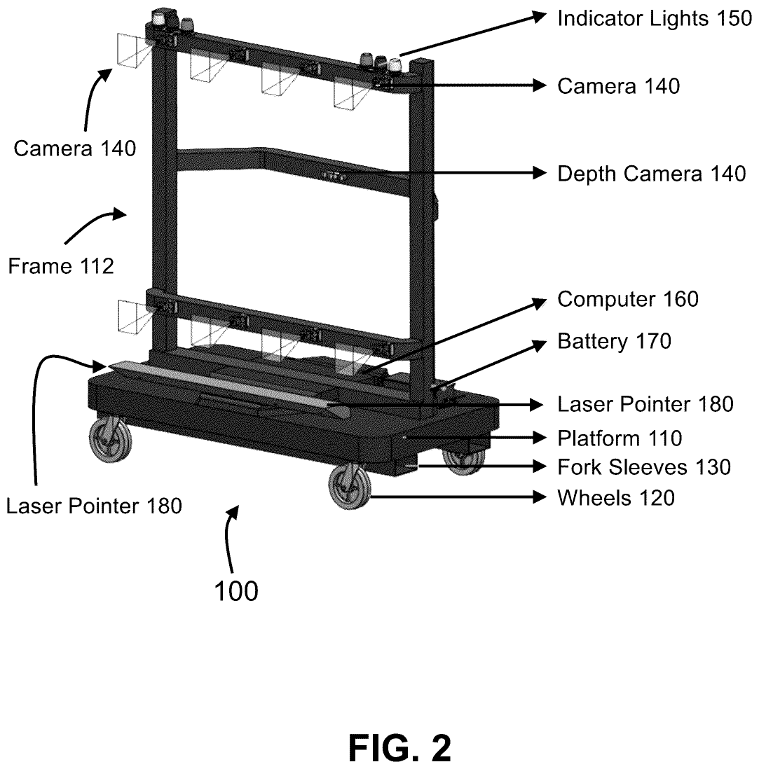

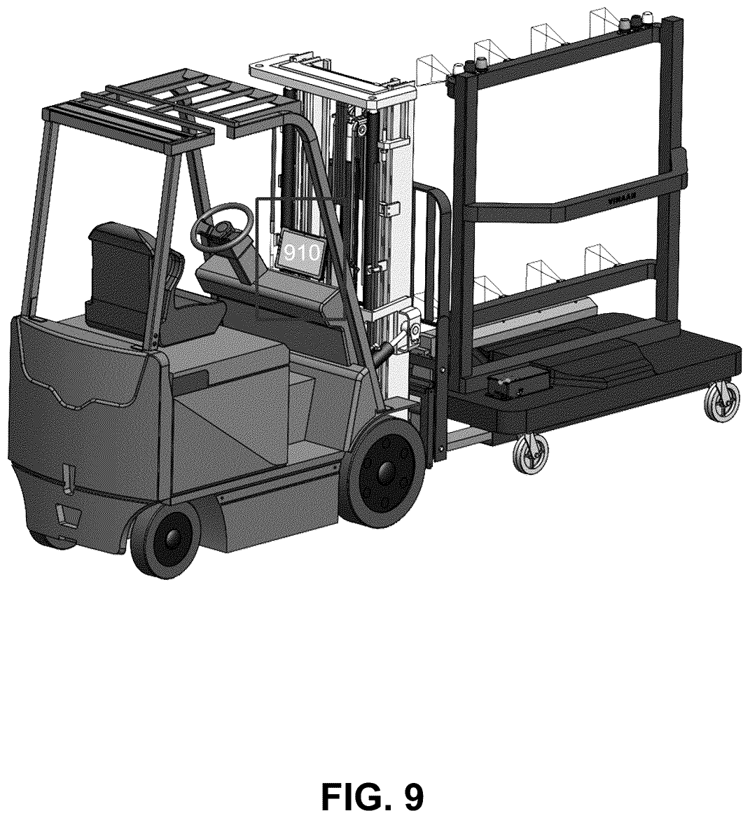

This invention pertains to warehouses that operate material handling equipment that have forks, have tall shelving to store inventory and are laid out in the form of multiple long aisles. The proposal in this invention is to use a mobile sensor frame 100 with a platform 110 wheels 120 and pallet like geometry with fork-like tubes/sleeves 130 to allow lifting by a MHE with forks shown in FIGS. 1-2. Sensor frame 100 is equipped with multiple cameras 140 ((indicator)-lights 150, one or more companion computers 160, independent battery pack 170, laser pointers 180 and an operator UI 910 as shown in FIG. 2 and FIG. 9. Some of the items are positioned (and distributed) on a frame 112 which is mounted at the top surface of the platform.

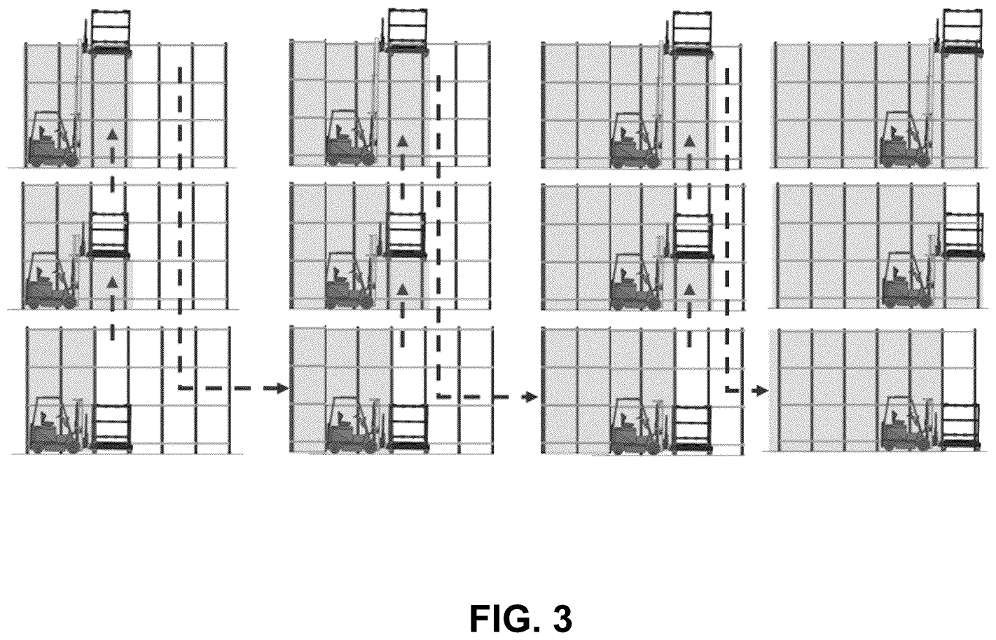

The software backend includes a pipeline to acquire, process, aggregate, and present data to the end user. The hardware design features, and software backend enable an MHE to become an inventory tracker on demand. This frame can attach to be lifted by any MHE in the warehouse and the operator can sweep the area in repeated vertical or horizontal scans as shown in FIG. 3. This allows a significant improvement in time to perform an inventory audit and provide more insights by processing camera images instead of a barcode scan.

Vimaan has already disclosed the advantages of camera-based inventory scanning as compared to barcode scanning in a previous patent application U.S. Ser. No. 17/638,972 filed Feb. 28, 2022, which is incorporated herein by reference. Main advantages of utilizing computer vision are listed here:
Differentiate between labels and selectively read label of interest
Multi-Case Label Reading & Association
ID packages with missing labels
Detect damages to packages
Photographic evidence for pallets and packages
Dimension pallets and packages along with ID
Counting cases and eaches with or without labels
Multi-label reading & cross validation
Empty Bin Identification

There are several design features that make up the embodiments of the invention. Following is the description of these features in a preferred embodiment.

Mobile Frame Liftable by Forklift

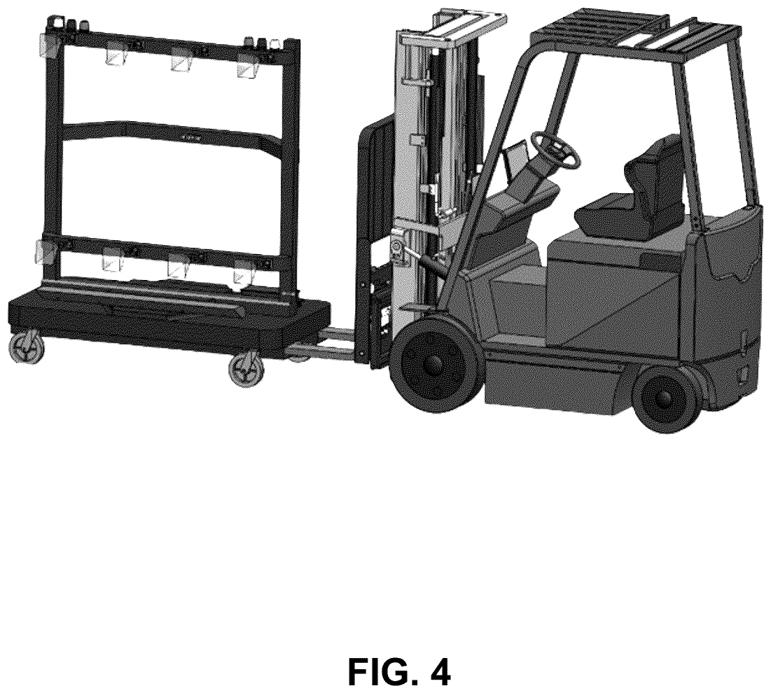

Sensor frame is designed with wheels so moving the sensor package inside the warehouse is ergonomic and easy. The frame is also designed with fork tubes or sleeves 130 (FIG. 4) so an MHE can lift the frame without the need of any heavy lifting by the operator. The operator does not even need to get down of the MHE to attach the frame.

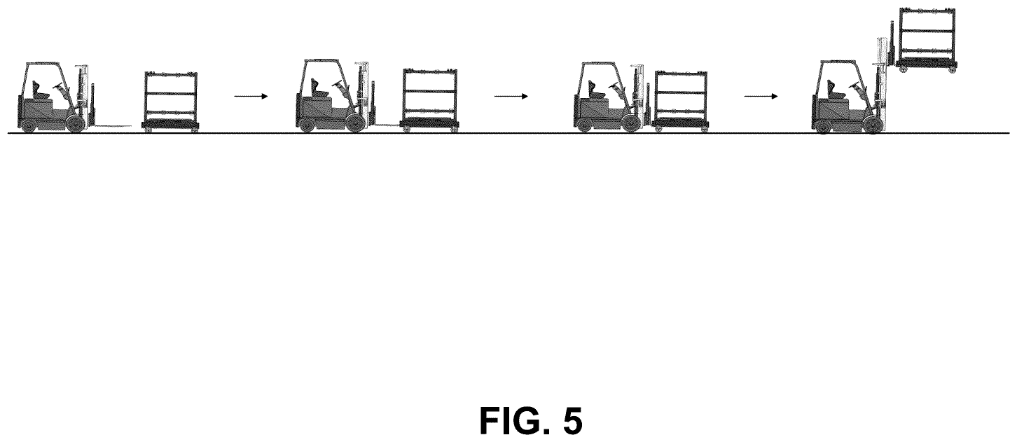

If the sensor frame is parked at a location in the warehouse, the forklift can pick up the sensor frame like a pallet and navigate to a desired location in the warehouse to start scanning. FIG. 5 Error! Reference source not found. shows the ease with which the sensor frame can be attached to the forklift and be ready to use. It is important to emphasize that the operator doesn't need to get down off the vehicle to use the system. This improves operator experience and safety.

Multiple Camera Array

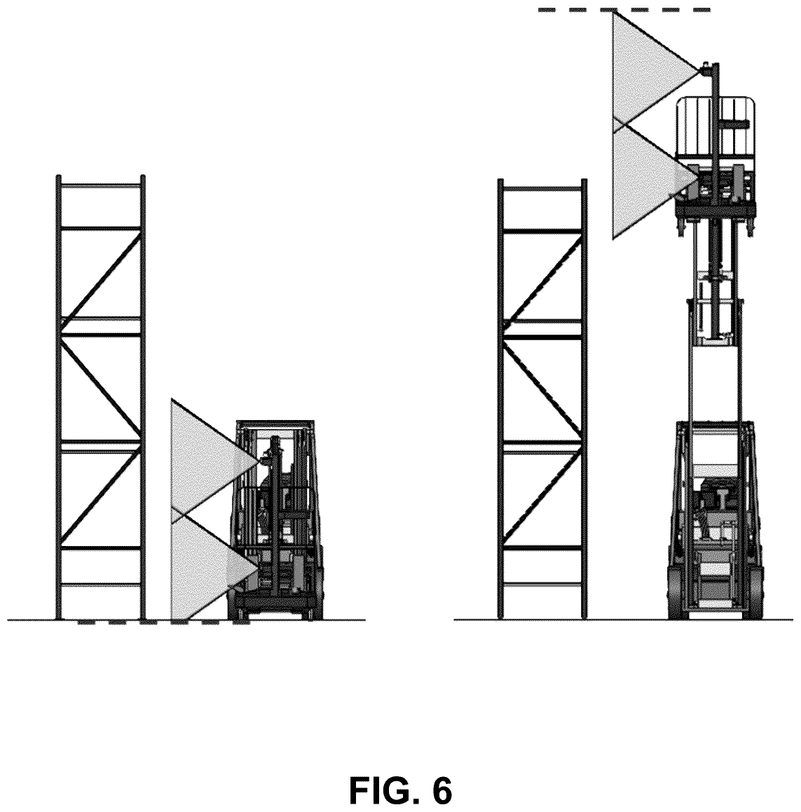

Multiple (high-definition) cameras are mounted on the frame horizontally to allow capturing several items in one vertical sweep, reducing the scan time tremendously. There is also another row of cameras to cover all the way from bottom to the top of the shelf without needing to take the forks higher than necessary, preventing any chances of roof collisions (FIG. 6).

Laser Pointers and Camera Feed on Operator UI for Conveying Capture

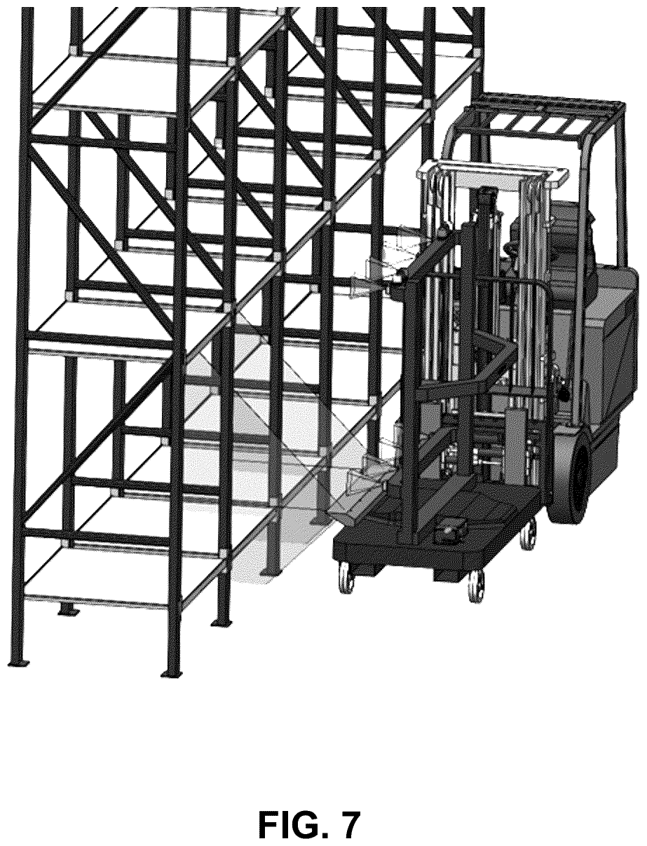

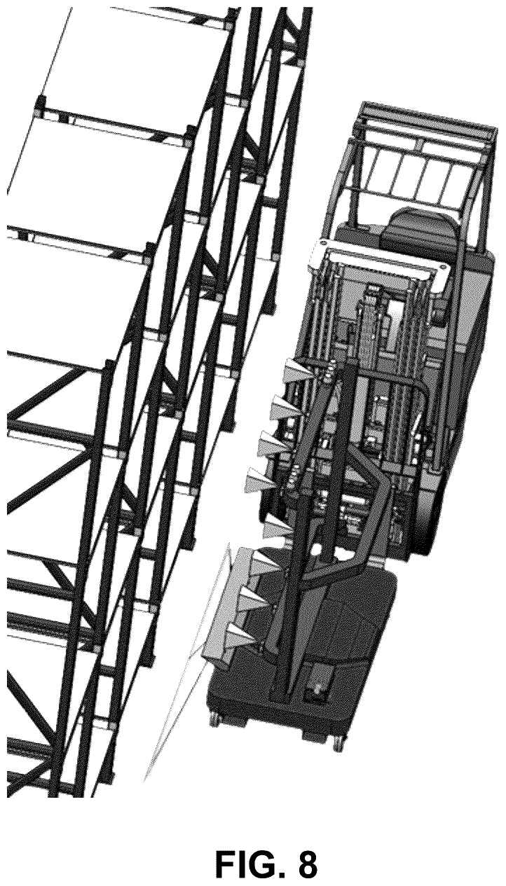

Laser line pointers assist operator to align the forklift in the close to precise location with high confidence. Vertical pointers in FIG. 7 provide accurate feedback on the positioning along the racks. Horizontal pointer shown in FIG. 8 located on the ground provides feedback on the distance from the rack and parallelism to the racks. The line can be aligned at the base of the uprights to maintain the correct distance from the rack and parallel angle orientation. The operator UI screen provides camera feed to show the capture area.

Operator UI Description

Battery Pack

An onboard battery pack provides power to operate cameras, lights, and companion computer. It can provide enough power to last for one full shift (˜8 hours or more).

Processing for Location

An onboard localization system with cameras, lidar and range sensor will help identify location of the scan. The cameras that scan the labels for items can also read racking labels thus allowing association of item to the location.

Concept of Operations

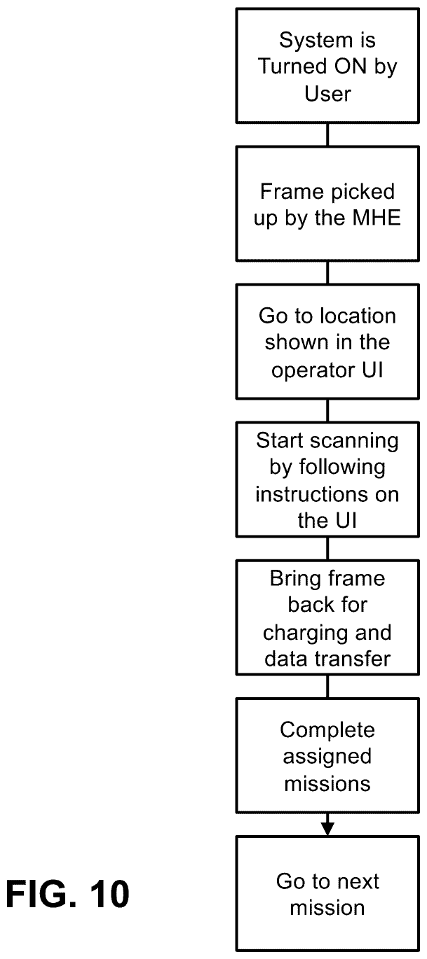

The system can be run in either a manual mode or an assisted mode which the user can select at startup. This offers the user flexibility, but the primary use case will be the assisted mode. FIG. 10 describes a high-level flow of operations. Below is a more detailed description of the concept of operations.

Assumptions
1. The system will return to home base after operation. “Home Base” is a physical location where the system can be charged, and a Wi-Fi network is available.
2. When the user has completed all the tasks, the system needs to return to home base to access a new list of tasks.

In Assisted Mode
1. The system starts up when powered on and the lights array provides feedback of the startup.
2. The system will receive a list of locations to be scanned from the mission generation engine via Wi-Fi.
3. The user picks the system up using the forks of the forklift. The system can be picked up in two orientations (0 or 180 degrees) and the sensors will detect the orientation and calibrate the system. The light array will indicate that the system is ready for use.
4. The display screen will continuously stream safety critical information to the user.
5. The screen will display a target location to the user. The target location is usually the left pylon of the shelf that needs to be scanned.
6. When the user reaches the location, camera streams and a navigation system will guide the user to the required position through the intuitive feedback/correction system.
7. The display screen will confirm that the forklift is in the target location and the camera—light modules will light up indicating that recording has started. The display screen will display a target ‘Z’ height to which the forks need to be raised to and feedback of the current height of the forks.
8. After the user has raised the forks to the target height, the recording is paused, and the display screen will instruct the user to lower the forks.
9. When the system detects that the forks have been lowered, the next target position is displayed on the screen along with intuitive feedback to get the user to the target position. Narrow shelves can be scanned with just one vertical pass, but wide shelves will need multiple passes. The system will determine the number of passes needed and accordingly, determine the target position of the forklift.
10. The process repeats until the given shelf is completely scanned. The system will now instruct the user to move to the next location.
11. A health monitor will continuously update the user about the status of the system including the battery level. If the battery level is low, the user can choose to return to return to the base station and recharge the system. The operation will resume when the system is charged.
12. After the user completes all the tasks, the user is instructed to return to the home base. At the home base, the system will transfer data to the server via Wi-Fi/ethernet and the user and plug in the charger.

What is claimed is:

1. A mobile sensor frame for warehouse inventory management, comprising:
(a) a platform with a bottom surface and a top surface;
(b) forklift sleeves distributed at the bottom surface or the top surface of the platform to allow a forklift truck to insert the forks into two of the forklift sleeves;
(c) a vertically oriented frame mounted at the top surface of the platform;
(d) a motor-controlled translation system for moving the vertically oriented frame in vertical direction along with the platform;
(e) multiple cameras distributed on the vertically oriented frame; and
(f) an on-board computer for controlling operational control of the mobile sensor frame by monitoring the direction of motion of the mobile sensor frame relative to a ground surface, and performing data acquisition of the multiple cameras.

2. The mobile sensor frame as set forth in claim 1, wherein the controlling further comprises controlling the motor-controlled translation system for moving the vertically oriented frame in vertical direction relative to the platform.

3. The mobile sensor frame as set forth in claim 1, further comprising wheels distributed at the bottom surface of the platform.

4. The mobile sensor frame as set forth in claim 1, further comprising laser pointers for assisting in the controlling of operational control.

5. A warehouse inventory management acquisition method, comprising:
(a) having a mobile sensor frame wherein the mobile sensor frame comprises:
(i) a platform with a bottom surface and a top surface;
(ii) forklift sleeves distributed at the bottom surface or the top surface of the platform to allow a forklift truck to insert the forks into two of the fork-lift sleeves;
(iii) a vertically oriented frame mounted at the top surface of the platform;
(iv) a motor-controlled translation system for moving the vertically oriented frame in vertical direction along with the platform;
(v) multiple cameras distributed on the vertically oriented frame; and
(vi) an on-board computer for controlling operational control of the mobile sensor frame by monitoring the direction of motion of the mobile sensor frame relative to a ground surface, and performing data acquisition of the multiple cameras;
(b) the mobile sensor frame controlling movement and positioning through aisles in a warehouse or being remotely-controlled movement and positioning through aisles in a warehouse, wherein the warehouse comprises racks with inventory; and
(c) acquiring inventory information of the inventory using the multiple cameras while the vertically oriented frame is translated in the vertical direction relative to the platform.
